(19) United States
(12) Patent Application Publication
(10) Pub. No.: US 2025/0217419 A1
(43) Pub. Date: Jul. 3, 2025

(54) INFORMATION GENERATION METHOD AND APPARATUS, AND NON-TRANSITORY COMPUTER-READABLE STORAGE MEDIUM

(71) Applicant: Beijing Zitiao Network Technology Co., Ltd., Beijing (CN)

(72) Inventors: Wenchao WANG, Beijing (CN); Jinghua LI, Beijing (CN)

(21) Appl. No.: 18/929,413

(22) Filed: Oct. 28, 2024

(30) Foreign Application Priority Data
Dec. 28, 2023 (CN) 202311845584.8

(51) Int. Cl. G06F 16/903; G06F 16/9038

(52) U.S. Cl. CPC G06F 16/90335; G06F 16/9038

(57) ABSTRACT

The present disclosure relates to an information generation method and apparatus, a computer-readable storage medium, and a program product, and relates to the field of data processing and the field of terminal technologies. The information generation method includes: determining, based on intention information of a topic, whether the topic reflects key information of one or more topic posts of the topic; determining, in response to the topic not reflecting the key information of the topic posts, supplementary information of the topic based on the topic posts; and displaying the topic and the supplementary information.

### CROSS-REFERENCE TO RELATED APPLICATION

The present disclosure is based on and claims the priority of Chinese Patent Application for invention No. 202311845584.8, filed on Dec. 28, 2023, the disclosure of which is hereby incorporated into this disclosure by reference in its entirety.

### TECHNICAL FIELD

The present disclosure relates to the field of data processing and the field of terminal technologies, and in particular, to an information generation method and apparatus, and a non-transitory computer-readable storage medium.

### BACKGROUND

On the Internet, users can exchange topics of interest through various types of websites or applications. For example, a plurality of topics may be set. Under each topic, users may post topic posts about the topic. For example, in a reading-related topic, each user may post a topic post to express reading experience, recommend books, and the like.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to some embodiments of the present disclosure, there is provided an information generation method, including: determining, based on intention information of a topic, whether the topic reflects key information of one or more topic posts of the topic; determining, in response to the topic not reflecting the key information of the topic posts, supplementary information of the topic based on the topic posts; and displaying the topic and the supplementary information.

According to some other embodiments of the present disclosure, there is provided an information generation apparatus, including: a first determining module configured to determine, based on intention information of a topic, whether the topic reflects key information of one or more topic posts of the topic; a second determining module configured to determine, in response to the topic not reflecting the key information of the topic posts, supplementary information of the topic based on the topic posts; and a first display module configured to display the topic and the supplementary information.

According to some embodiments of the present disclosure, there is provided an information generation apparatus, including: a memory; and a processor coupled to the memory and configured to perform the information generation method according to any one of the embodiments of the present disclosure based on instructions stored in the memory.

According to some embodiments of the present disclosure, there is provided a non-transitory computer-readable storage medium having stored thereon a computer program that, when executed by a processor, causes the information generation method according to any one of the embodiments of the present disclosure to be implemented.

Other features, aspects, and advantages of the present disclosure will become apparent from the following detailed description of exemplary embodiments of the present disclosure with reference to the accompanying drawings.

### BRIEF DESCRIPTION OF THE DRAWINGS

Preferred embodiments of the present disclosure are described below with reference to the

accompanying drawings. The accompanying drawings described here are provided to further understand the present disclosure. The accompanying drawings, together with the following specific description, are incorporated into and form a part of the specification, and are used to explain the present disclosure. It should be understood that the accompanying drawings in the following description merely relate to some embodiments of the present disclosure, and do not constitute a limitation on the present disclosure. In the drawings:

FIG. 1 is a schematic flowchart of an information generation method according to some embodiments of the present disclosure;

FIG. 2 is a schematic flowchart of a method for determining key information according to some embodiments of the present disclosure;

FIG. 3 is a schematic diagram of a topic list according to some embodiments of the present disclosure;

FIG. 4 is a schematic diagram of a topic list according to some other embodiments of the present disclosure;

FIG. 5 is a schematic diagram of a topic details page according to some embodiments of the present disclosure;

FIG. 6 is a schematic diagram of a structure of an information generation apparatus according to some embodiments of the present disclosure;

FIG. 7 is a schematic diagram of a structure of an electronic device according to some embodiments of the present disclosure; and

FIG. 8 is a block diagram of an example structure of a computer system that can be used in embodiments of the present disclosure.

It should be understood that, for ease of description, the dimensions of the various parts shown in the drawings are not necessarily drawn in accordance with actual proportional relationships. The same or similar reference signs are used in the drawings to denote the same or similar parts. Therefore, once an item is defined in one drawing, it may not be further discussed in the subsequent drawings.

### DETAILED DESCRIPTION

The technical solutions in the embodiments of the present disclosure are clearly and completely described below with reference to the accompanying drawings in the embodiments of the present disclosure. Apparently, the described embodiments are merely some but not all of the embodiments of the present disclosure. The descriptions of the embodiments are actually only illustrative and shall not be construed as any limitation to the present disclosure and its application or use. It should be understood that the present disclosure may be implemented in various forms and should not be interpreted as being limited to the embodiments set forth herein.

It should be understood that the various steps described in the method implementations of the present disclosure may be performed in different orders, and/or performed in parallel. Moreover, additional steps may be included and/or the execution of the illustrated steps may be omitted in the method implementations. The scope of the present disclosure is not limited in this respect. Unless otherwise specified, the relative arrangement of the components and steps, the numerical expressions, and the values set forth in these embodiments should be construed as merely exemplary and not limiting the scope of the present disclosure.

The term “include/comprise” used in the present disclosure and the variations thereof are an open term, namely, “include/comprise but not limited to”. In addition, the term “include/contain” used in the present disclosure and the variations thereof are an open term, namely, “include/contain but not limited to”. Therefore, “include/comprise” and “include/contain” are synonyms. The term “based on” means “at least partially based on”.

The term “one embodiment”, “some embodiments”, or “an embodiment” mentioned throughout the specification means that a specific feature, structure, or characteristic described in conjunction with the embodiment is included in at least one embodiment of the present invention. For example, the term “one embodiment” means “at least one embodiment”; the term “another embodiment” means “at least one another embodiment”; and the term “some embodiments” means “at least some embodiments”. Moreover, the appearances of the phrase “in one embodiment”, “in some embodiments” or “in an embodiment” in various places throughout the specification are not necessarily all referring to the same embodiment, but may refer to the same embodiment.

It should be noted that concepts such as “first” and “second” mentioned in the present disclosure are only used to distinguish between different apparatuses, modules, or units, and are not used to limit the sequence or interdependence of functions performed by these apparatuses, modules, or units. Unless otherwise specified, the concepts such as “first” and “second” are not intended to imply that the objects described in this way must be in a given order in terms of time, space, ranking, or in any other way.

It should be noted that the modifiers “one” and “a plurality of” mentioned in the present disclosure are illustrative and not restrictive, and those skilled in the art should understand that unless the context clearly indicates otherwise, it should be understood as “one or more”.

The names of messages or information exchanged between a plurality of apparatuses in the implementation manners of the present disclosure are used for illustrative purposes only, and are not used to limit the scope of these messages or information.

Embodiments of the present disclosure are described in detail below with reference to the accompanying drawings, but the present disclosure is not limited to these specific embodiments. These specific embodiments below may be combined with each other, and for the same or similar concepts or processes, some embodiments may not be described again. In addition, in one or more embodiments, specific features, structures, or characteristics may be combined in any suitable manner from the present disclosure by those of ordinary skill in the art.

In some applications, users can freely create topics, so that the topics can cover various needs of various users, have high degrees of freedom, and can also make the topics closely follow current hotspots. However, due to limitations of a user's expression ability or the user's language style, information in the topic itself may be difficult to clearly express an intention. Alternatively, as the number of topic posts in a topic increases, a topic discussed in the topic posts may have deviated from the original intention of the topic, or when two topics expressing similar content are present, discussion content in the topic posts of the topics focuses on different aspects. Therefore, information in the topic itself, for example, a title and description information of the topic, has difficulty in effectively conveying key information of the topic posts in the topic.

When the topic fails to effectively convey information, it may cause users' misclicks. For example, when a user selects a topic A based on a title of the topic and views topic posts of the topic A, the user finds that no available information is found. Then, the user selects a topic B, a topic C, and the like in sequence, and still no available information is found. It is not until the user selects a topic X that the user finds the desired content from a topic post in the topic X. This causes the topic to fail to convey effective information, so that a plurality of unnecessary topics and topic posts are requested to be sent and displayed, thereby wasting network resources and computing resources, and reducing the efficiency of the user's information search and information acquisition.

In order to at least partially solve the above problems, the present disclosure proposes an information generation method and apparatus, a computer-readable storage medium, and a program product. In the embodiments of the present disclosure, supplementary information of a topic is determined based on intention information of the topic and one or more topic posts of the topic, and the topic and the supplementary information are displayed. When the intention of the topic is inaccurate, that is, when the topic cannot reflect the key information of the topic posts of the topic, the supplementary information generated based on the topic posts is also displayed when the topic is displayed, to improve the efficiency of information transmission.

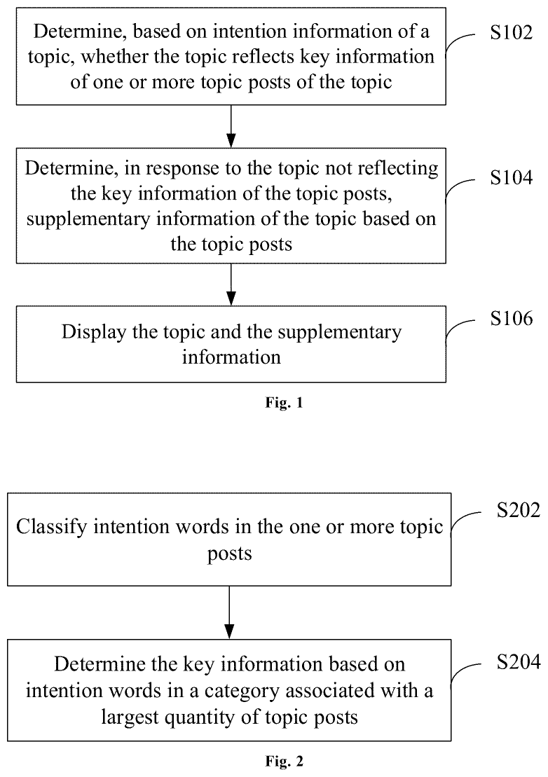

FIG. 1 is a schematic flowchart of an information generation method according to some embodiments of the present disclosure. As shown in FIG. 1, the information generation method in this embodiment includes steps S102 to S106.

In step S102, whether a topic reflects key information of one or more topic posts of the topic is determined based on intention information of the topic.

One topic corresponds to one or more topic posts. The topic may be regarded as an entry to a set of the one or more topic posts. The topic may be preset in an application, or created and posted by a user. The topic includes a title, and some topics may further include description information (brief introduction). For example, a topic is “Tell your favorite detective novel”, and the description information is “The year, the author, and the style are not limited. Welcome to recommend!”. The topic may include some topic posts, some of the topic posts include recommendations or evaluations for detective novels, and some of the topic posts may discuss detective novel authors.

The intention refers to core content to be expressed by the topic, and may be reflected by using an intention word. However, descriptions of some topics are too ambiguous, and there may be a case where there is no intention or the intention is not clear. Therefore, the intention information may be an intention word (which may be one or more), or may indicate whether the topic has an intention. For example, a certain topic is expressed ambiguously and has no intention, and the intention information thereof may be empty, or “the topic has no intention”, or a parameter value indicating that the topic has no intention.

The intention of the topic may be determined through semantic analysis of the topic. For example, text (for example, at least one of a title and description information) of the topic may be processed by using a machine learning model such as an intention analysis model to obtain the intention information of the topic. The intention analysis model may be obtained through training by using labeled training data, and the training data may be a title or description information of some topics, and the label information thereof may be, for example, an intention word, and the number of intention words may be one or more.

The topic posts of the topic refer to topic posts posted under the topic. The topic posts are posted by users, and include text, and may further include multimedia information such as an image, a video, and an audio, or include book information that may be reflected by using an identifier or a link of a book. Ideally, the topic posts should be centered around the topic. Certainly, there may also be a case where a topic post deviates from the topic, or a case where the topic post focuses on one of a plurality of intentions of the topic.

The key information of the one or more topic posts refers to information conveyed by the one or more topic posts as a whole. The information may not completely cover the content of all the topic posts, but can reflect important content in the topic posts. In some embodiments, the key information may be obtained by analyzing intentions of the topic posts. For example, the key information may be representative intention words extracted from the intention words in the one or more topic posts. The representative intention words may be one or more intention words with a frequency of occurrence greater than a specified frequency or a ranking of the frequency of occurrence higher than a specified ranking, or may be a word that can cover one or more intention words with a frequency of occurrence greater than a specified frequency or a ranking of the frequency of occurrence higher than a specified ranking.

In some embodiments, some of the one or more topic posts may also be directly used as the key information.

It should be noted that the key information may be determined or not determined before it is determined whether the topic reflects the key information of the one or more topic posts. For example, when the intention information of the topic indicates that the topic has no intention, regardless of what the key information of the topic posts is specifically, the topic obviously cannot reflect the key information. Therefore, in some embodiments, whether the topic has an intention may be first determined. If the topic has no intention, it is directly determined that the topic cannot reflect the key information. If the topic has an intention, it is further determined what the key information is, and then it is determined whether the topic can reflect the key information.

In step S104, in response to the topic not reflecting the key information of the topic posts, supplementary information of the topic is determined based on the topic posts.

The supplementary information is used to supplementally describe the intention of the topic. The supplementary information may be a sentence or one or more words, and the sentence or words may come from original text of the topic posts, or may be generated by processing some of the topic posts. The supplementary information may also be information about one or more books, or information about one or more authors of books.

The supplementary information can make the intention of the topic clearer. For example, when the topic has no intention, the supplementary information can clarify the intention. For another example, when discussion content in most of the topic posts of the topic has deviated from the topic, the supplementary information can reflect the content discussed in most of the topic posts.

In step S106, the topic and the supplementary information are displayed. That is, the supplementary information may be displayed together with the topic. For example, in a topic list, the topic and the supplementary information of the topic are displayed. The topic list may include a plurality of topics for a user to browse and select, for example, each topic corresponds to an entry, and each entry is a triggerable control. In the plurality of topics, for a topic that does not reflect the key information, the supplementary information may be further displayed in the entry, so that the user can clearly understand key content discussed in the topic posts of the topic.

In the above embodiments, when the topic does not include the key information of the topic posts, the supplementary information of the topic is determined based on the topic posts and displayed. Therefore, it is not necessary to click on the topics one by one to view the specific content of the topic posts under the topics to find the target topic, thereby improving the efficiency of information transmission. By reducing clicks on non-target topics, network resources and computing resources are also saved.

The key information of the topic posts may also be obtained through intention analysis. An embodiment of a method for determining the key information of the present disclosure is described below with reference to FIG. 2.

FIG. 2 is a schematic flowchart of a method for determining key information according to some embodiments of the present disclosure. As shown in FIG. 2, the determining method in this embodiment includes steps S202 and S204.

In step S202, intention words in one or more topic posts are classified.

Similar to the topic, each topic post may have an intention or no intention. Therefore, intention analysis may also be performed on the topic posts to obtain intention information. The intention information may indicate whether a topic post have an intention, or may reflect the intention words in a topic post. There may be one or more intention words in the topic posts. The intention words in the topic posts may also be obtained through semantic analysis. For example, a topic post is processed by using an intention analysis model to obtain the intention information of the topic post. The intention analysis model may be the same as or different from the intention analysis model used to obtain the intention of the topic.

By classifying the intention words, several intentions under the topic may be determined. For example, a topic is “Whether a book M is worth reading”, some of the topic posts under the topic indicate that the book M is worth reading, some of the topic posts indicate that the book M is not worth reading, and some of the topic posts discuss a book N related to the book M. Through the classification of the intention words, several discussion directions of the topic posts may be determined.

The intention words may be classified in several ways. Two of them are described below as examples.

In some embodiments, the intention words in the one or more topic posts may be clustered. During the clustering, for example, the similarity between the intention words is used as the “distance” between the intention words, so that similar intention words are clustered into one category as much as possible. The similarity between the intention words may be determined by word embedding vectors of the intention words, for example, an included angle between the word embedding vectors. By the clustering manner, a plurality of categories can be naturally formed based on the characteristics of the topic posts themselves, without the need for too much pre-configuration, and applicable to topics including various quantities of topic posts.

In some embodiments, a dimension to which each of the intention words in the one or more topic posts belongs is determined, and the intention words in the one or more topic posts are classified based on the dimension. A correspondence between the intention word and the dimension may be determined by using a preset correspondence table, the correspondence table including a plurality of dimensions and a plurality of intention words under each dimension. Alternatively, the intention words may be processed by using a classification model or another machine learning model to determine the dimension to which each of the intention words belongs. By presetting the dimension information and classifying based on the dimension information, it is convenient to perform more standardized classification on the topic posts, and a subject of each category can be expected.

In some embodiments, the dimensions comprises at least one of an author, a plot, a subject, an evaluation, or a book status. Therefore, discussion directions focused on by the topic posts may be determined, that is, from which angle the topic posts discuss a book. Therefore, in a book discussion and recommendation scenario, more useful information can be transmitted to viewers, thereby improving the efficiency of information distribution.

In step S204, the key information is determined based on intention words in a category associated with a largest quantity of topic posts.

Because there is an correlation between the intention words and the topic posts, after the categories of the intention words are determined, the classification of the topic posts may be determined. If there are a large quantity of topic posts corresponding to a certain category, it indicates that the topic posts in the category reflect the mainstream opinions or the mainstream discussion direction under the topic. Therefore, the key information may be extracted from the intention words of these topic posts.

For example, one or more intention words with a highest frequency of occurrence in this category may be determined as the key information. For another example, a preset standard word list may be used, and intention words in the category and located in the standard word list may be determined as the key information. For another example, the intention words in the category may be processed by using a machine learning model with a semantic analysis function to obtain output information that is similar or identical to these words in semantics and can cover most of these words, and the output information is used as the key information.

In the above embodiments, the category that can provide the key information is determined based on the classification result of the intention words, and the key information is extracted from the intention words in the category, so that the key information can reflect main discussion content of the one or more topic posts under the topic. According to requirements, those skilled in the art may also determine the key information in other manners, for example, screen the categories according to a predetermined strategy, and retain a category associated with a largest quantity of topic posts after screening.

Two manners of determining whether the topic reflects the key information of the one or more topic posts of the topic are described below as examples.

In some embodiments, in response to the intention information of the topic indicating that the topic has no intention, it is determined that the topic does not reflect the key information of the topic posts. That is, regardless of what the key information of the topic posts is, if the topic has no intention, it may be determined that the topic does not reflect the key information of the topic posts.

When the topic has no intention, an intention with a highest frequency of occurrence in the topic posts may be used as the key information, for example, in the manner in the embodiment shown in FIG. 2. Then, the supplementary information is determined based on the topic posts in which intentions corresponding to the key information occur. Therefore, the mainstream opinions in the topic posts may be reflected by the supplementary information.

When the intention information indicates that the topic has an intention, whether the topic reflects the key information of the one or more topic posts of the topic may be further determined based on a matching result of the intention words of the topic and the key information. In some embodiments, the key information of the topic posts is determined based on the intention words in the one or more topic posts; in response to the intention words of the topic matching the key information of the one or more topic posts, it is determined that the topic reflects the key information of the topic posts of the topic; and in response to a determination that the intention words of the topic not matching the key information of the one or more topic posts, it is determined that the topic does not reflect the key information of the topic posts of the topic. Whether the intention words of the topic match the key information of the topic posts may be obtained by calculating the similarity between them. For example, a word vector of the intention word and a document vector of the key information (which may be obtained by using word vectors of words in the key information) are determined, and a distance between the vectors is calculated.

When the topic has an intention, an intention with a highest frequency of occurrence in the topic posts may also be used as the key information, with reference to the manner when the topic has no intention. However, if the intention of the topic is not an intention with a highest frequency of occurrence in the topic posts, and is not an intention with a relatively low frequency of occurrence, the supplementary information may also be used to enhance the original intention of the topic.

In some embodiments, a ratio of a quantity of topic posts that match the intention of the topic to a quantity of the one or more topic posts is determined based on the intention word of the topic and the intention words of the one or more topic posts. If the ratio is greater than a first threshold, it indicates that a large quantity of topic posts discuss content related to the topic, and the topic posts that match the intention of the topic may be used as the key information, and in this case, the topic posts that match the intention of the topic may be determined as the topic posts related to the key information, and then the supplementary information is determined based on the topic posts related to the key information. In response to the ratio not being greater than the first threshold, that is, content currently discussed in the topic posts has seriously deviated from the intention of the topic, the topic posts are classified based on the intention words of the one or more topic posts, and the topic posts in the category with a largest quantity of topic posts are determined as the topic posts related to the key information, that is, these topic posts may be regarded as the key information.

How to determine the supplementary information is further described below.

In some embodiments, the supplementary information of the topic is determined based on the topic posts related to the key information. For example, the key information may be first determined, and then from which topic posts the key information comes is determined. For another example, the intention word of the topic is directly matched with the intention words in the topic posts. In response to a determination that a matching result meets a specified condition (for example, a ratio of a quantity of matched topic posts to a quantity of the one or more topic posts is greater than a first threshold), it is considered that the topic reflects the key information of the topic posts, and the matched topic posts are the topic posts related to the key information. In this case, a specific content of the key information may be determined or may not be determined.

The supplementary information may come from original content of the topic posts. For example, text, or a recommended book, or a recommended author of at least one of the topic posts related to the key information is used as the supplementary information. In some embodiments, in response to the key information being text (for example, text determined based on the intentions of the topic posts), a type of the supplementary information is determined based on a type of content in the key information. For example, if the type of the key information is related to a plot or a subject, the supplementary information is text. If the key information is a recommended book, the supplementary information is information about the book, for example, a name of the book, a reading link, a purchase link, and the like. If the type of the key information is an author, the supplementary information is information about the author, for example, a name, an author homepage, and the like.

In some embodiments, target topic posts (that is, the “at least one topic post”) are first screened from the topic posts related to the key information, and then the supplementary information is extracted from the target topic posts. For example, topic post(s) with highest amount of information are determined from the topic posts related to the key information as target topic post(s), wherein a quantity of the target topic posts may be one or more. The amount of information of a topic post is determined based on at least one of text of the topic post, publisher information of the topic post, information about a recommended book of the topic post, intention information of the topic post, and a correlation with the topic of the topic post. In some embodiments, at least one of the text, the publisher information, the information about the recommended book, the intention information, and the correlation with the topic of the topic post is processed by using a machine learning model such as an information quantity determination model to obtain the amount of information output by the information quantity determination model. The amount of information may be represented by using a continuous value. Alternatively, the amount of information may be represented by using a discrete value, for example, several preset information quantity levels.

When the text is extracted from the target topic posts, all the original text may be directly used as the supplementary information, or the text most matched with the intention corresponding to the key information may be extracted from the target topic posts through semantic analysis as the supplementary information.

When the recommended books are extracted from the target topic posts, books appearing in the target topic posts may be counted, and books with a ranking of the number of occurrences higher than a specified ranking are used as the supplementary information.

When the recommended authors are extracted from the target topic posts, authors of books appearing in the target topic posts and authors directly appearing in the target topic posts may be counted, and authors with a ranking of the number of occurrences higher than a specified ranking are used as the supplementary information.

The supplementary information may also come from a semantic processing result of a plurality of topic posts. For example, the at least one of the topic posts related to the key information is processed by using a machine learning model to obtain the supplementary information output by the machine learning model. The supplementary information may be keywords or intention words of the target topic posts, or may be text generated after some text in the topic posts is fused. In some embodiments, the target topic post(s) (that is, the “at least one topic post”) are first screened from the topic posts related to the key information, and semantic analysis is performed on the target topic post(s) to generate the supplementary information.

For example, a model for generating text based on text may be used to process the target topic post(s) to generate the supplementary information. The model may be implemented by using a foundation model or a Large Language Model LLM for short).

The foregoing embodiments describe the method for generating the supplementary information. The display of the topic and the supplementary information is described below as an example.

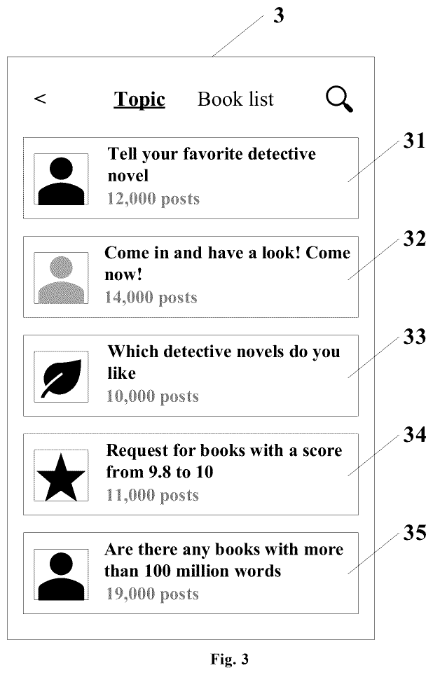

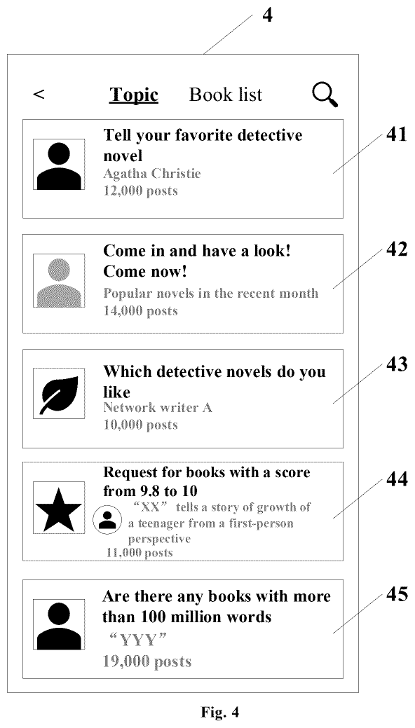

FIG. 3 is a schematic diagram of a topic list according to some embodiments of the present disclosure. In a topic list page 3, entries corresponding to topics 31 to 35 are included, and each entry includes an avatar of a publisher of the topic, a title of the topic, and a quantity of topic posts in the topic. In this embodiment, the supplementary information is not displayed, resulting in that useful information of some topics cannot be transmitted on this page. For example, in a topic 32 “Come in and have a look! Come now!”, the intention of the title is very ambiguous. The topic actually gathers books that users want to recommend very much, but it is difficult for viewers to clarify, through the title, content discussed in the topic posts under the topic. For another example, in a topic 31 “Tell your favorite detective novel” and a topic 33 “Which detective novels do you like”, intentions of the two topics are similar, but actually, the topic 31 focuses on discussion about classic detective novels, and the topic 33 focuses on discussion about popular network detective novels. Through the page 3, it is difficult to clarify the key information in the topic posts under each topic.

FIG. 4 is a schematic diagram of a topic list according to some other embodiments of the present disclosure. For ease of comparison and description, in a topic list page 4, topics 41 to 45 are the same as the topics 31 to 35 in the embodiment shown in FIG. 3. Different from the topic list in the topic list page 3, each entry in the topic list page 4 further includes the supplementary information of the topic. For example, the supplementary information of the topic 41 is a writer Agatha Christie, and the supplementary information of the topic 43 is a network writer A. By adding the writer information as the supplementary information, the writer mainly discussed in the topic posts of the topic 41 and the writer mainly discussed in the topic posts of the topic 43 can be indicated. The supplementary information of the topic 42 is text generated based on a semantic analysis result of the topic posts of the topic 42. Through analysis, the topic 42 mainly relates to popular novels in the recent month, so that the supplementary information “Popular novels in the recent month” can clearly reflect this point. The supplementary information of the topic 44 is some original text of a topic post in the topic and an avatar of a user who posts the topic post, so that viewers can intuitively understand content discussed in a topic post with a large amount of information under the topic. The supplementary information of the topic 45 is a book “YYY”, so that users can more directly obtain popular books under the topic.

In the above embodiments, information in the topic posts is exposed in the topic list to supplement the topics, so that viewers can efficiently acquire the key information in the topic posts without viewing details of the topics, thereby improving the efficiency of information acquisition.

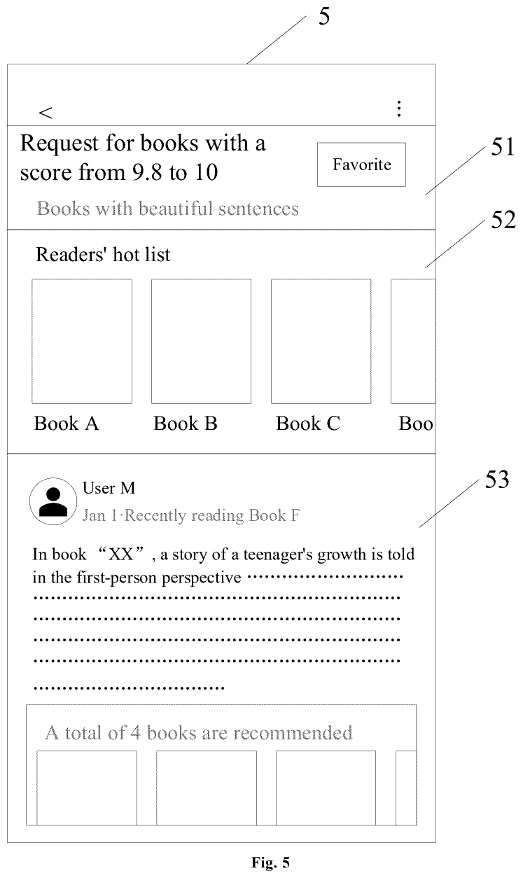

In some embodiments, in response to a triggering operation on the topic, a presentation page is displayed, where the presentation page is configured to present the one or more topic posts. FIG. 5 is a schematic diagram of a topic details page according to some embodiments of the present disclosure. In a topic details page 5, a display element 51 includes a title “Request for books with a score from 9.8 to 10” of the topic and a brief introduction “Books with beautiful sentences” of the topic, and the brief introduction is written by the publisher of the topic. A display element 52 includes a list of recommended books in the topic. A display element 53 includes one or more topic posts. FIG. 5 shows, by way of example, a topic post posted by a user M, which includes text of the topic post and a book recommended by the user M for the topic. Viewers can view more topic posts through a sliding operation.

The foregoing embodiments are described based on the case that the topic does not reflect the key information of the topic posts, and the supplementary information is generated based on the topic posts. In some embodiments, the supplementary information may also be description information of the topic, for example, a brief introduction of the topic. When the topic reflects the key information of the topic posts, only the original content of the topic, for example, the title, or the title and the description information, may be displayed, or the supplementary information may be further displayed to provide more reference information for viewers. Those skilled in the art may make a choice as required.

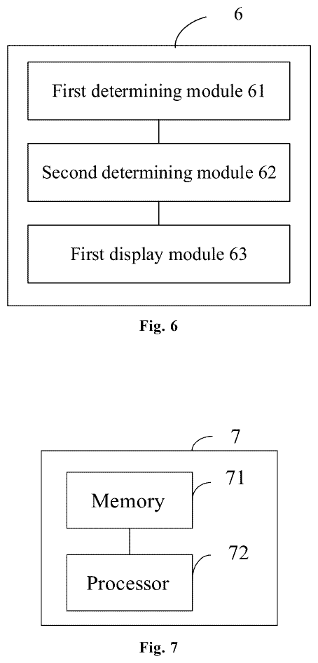

Embodiments of the information generation apparatus and related devices of the present disclosure are described below with reference to FIG. 6 to FIG. 8.

FIG. 6 is a schematic diagram of a structure of an information generation apparatus according to some embodiments of the present disclosure. As shown in FIG. 6, the information generation apparatus 6 in this embodiment includes: a first determining module 61 configured to determine, based on intention information of a topic, whether the topic reflects key information of one or more topic posts of the topic; a second determining module 62 configured to determine, in response to the topic not reflecting the key information of the topic posts, supplementary information of the topic based on the topic posts; and a first display module 63 configured to display the topic and the supplementary information.

In some embodiments, the information generation apparatus 6 further includes a key information determining module configured to: classify intention words of the one or more topic posts; and determine the key information based on intention word(s) in a category associated with a largest quantity of topic posts.

In some embodiments, the key information determining module is further configured to: cluster the intention words of the one or more topic posts; or determine dimension(s) to which the intention words of the one or more topic posts belong, and classify the intention words of the one or more topic posts based on the dimension(s).

In some embodiments, the first determining module 61 is further configured to determine, in response to the intention information of the topic indicating that the topic has no intention, that the topic does not reflect the key information of the topic posts.

In some embodiments, the first determining module 61 is further configured to: determine the key information of the topic posts based on the intention words of the one or more topic posts; in response to the intention words in the topic matching the key information of the one or more topic posts, determine that the topic reflects the key information of the topic posts of the topic; and in response to the intention words of the topic not matching the key information of the one or more topic posts, determine that the topic does not reflect the key information of the topic posts of the topic.

In some embodiments, the second determining module 62 is further configured to determine the supplementary information of the topic based on the topic posts related to the key information.

In some embodiments, the second determining module 62 is further configured to: use text, or a recommended book, or a recommended author of at least one of the topic posts related to the key information as the supplementary information; or process the at least one of the topic posts related to the key information by using a machine learning model to obtain the supplementary information output by the machine learning model.

In some embodiments, the at least one of the topic posts related to the key information is a topic post with a highest amount of information, and the amount of information in the topic post is determined based on at least one of text of the topic post, publisher information of the topic post, information about a recommended book of the topic post, intention information of the topic post, or a correlation with the topic of the topic post.

In some embodiments, the dimension comprises at least one of an author, a plot, a subject, an evaluation, or a book status.

In some embodiments, the information generation apparatus 6 further includes a second display module configured to display a presentation page for presenting the one or more topic posts in response to a triggering operation on the topic.

In some embodiments, the information generation apparatus 6 further includes a processing module configured to: process a title and description information of the topic by using an intention analysis model to obtain the intention information of the topic; or process the topic posts by using the intention analysis model to obtain the intention information of the topic posts.

It should be noted that the foregoing units are only logical modules divided according to specific functions implemented by the units, and are not used to limit specific implementation manners. For example, the units may be implemented in a software, hardware, or software-hardware combination manner. In actual implementation, the foregoing units may be implemented as independent physical entities, or may be implemented by a single entity (for example, a processor (such as a CPU or DSP) or an integrated circuit). In addition, the foregoing units are shown in dashed lines in the drawings, indicating that the units may not actually exist, and operations/functions implemented by the units may be implemented by the processing circuit itself.

In addition, although not shown, the device may further include a memory, which may store various information generated during operation of the device and each unit included in the device, a program and data for operation, data to be sent by a communication unit, and the like. The memory may be a volatile memory and/or a non-volatile memory. For example, the memory may include but is not limited to a random access memory (RAM), a dynamic random access memory (DRAM), a static random access memory (SRAM), a read-only memory (ROM), and a flash memory. Certainly, the memory may also be located outside the device. Optionally, although not shown, the device may further include a communication unit, which may be configured to communicate with another device. In an example, the communication unit may be implemented in an appropriate manner known in the art, for example, including communication components such as an antenna array and/or a radio frequency link, various types of interfaces, a communication unit, and the like. Details are not described herein again. In addition, the device may further include other components not shown, such as a radio frequency link, a baseband processing unit, a network interface, a processor, a controller, and the like. Details are not described herein again.

Some embodiments of the present disclosure further provide an electronic device. FIG. 7 is a schematic diagram of a structure of an electronic device according to some embodiments of the present disclosure. For example, in some embodiments, the electronic device 7 may be various types of devices, for example, may include but is not limited to mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. For example, the electronic device 7 may include a display panel, and the display panel is configured to display data and/or an execution result used in the solution of the present disclosure. For example, the display panel may be in various shapes, for example, a rectangular panel, an oval panel, or a polygon panel. In addition, the display panel may be not only a planar panel, but also a curved panel or even a spherical panel.

As shown in FIG. 7, the electronic device 7 in this embodiment includes: a memory 71 and a processor 72 coupled to the memory 71. It should be noted that the components of the electronic device 7 shown in FIG. 7 are merely examples and not limitations. According to actual application requirements, the electronic device 7 may further include other components. The processor 72 may control other components in the electronic device 7 to perform a desired function.

In some embodiments, the memory 71 is configured to store one or more computer-readable instructions. When the processor 72 runs the computer-readable instructions, the computer-readable instructions, when run by the processor 72, implement the method according to any one of the foregoing embodiments. For a specific implementation of each step of the method and related explanation content, refer to the foregoing embodiments. Details of the same parts are not described herein again.

For example, the processor 72 and the memory 71 may directly or indirectly communicate with each other. For example, the processor 72 and the memory 71 may communicate with each other over a network. The network may include a wireless network, a wired network, and/or any combination of a wireless network and a wired network. The processor 72 and the memory 71 may also communicate with each other through a system bus. This is not limited in the present disclosure.

For example, the processor 72 may be implemented as various appropriate processors, processing apparatuses, and the like, such as a central processing unit (CPU), a graphics processing unit (GPU), and a network processor (NP). Alternatively, the processor 72 may be a digital signal processor (DSP), an application-specific integrated circuit (ASIC), a field programmable gate array (FPGA), or another programmable logic device, a discrete gate or transistor logic device, or a discrete hardware component. The central processing unit (CPU) may be an X86 or ARM architecture or the like. For example, the memory 71 may include any combination of various forms of computer-readable storage media, for example, a volatile memory and/or a non-volatile memory. For example, the memory 71 may include a system memory, and the system memory stores, for example, an operating system, an application, a boot loader, a database, another program, and the like. Various applications, various data, and the like may also be stored in the storage medium.

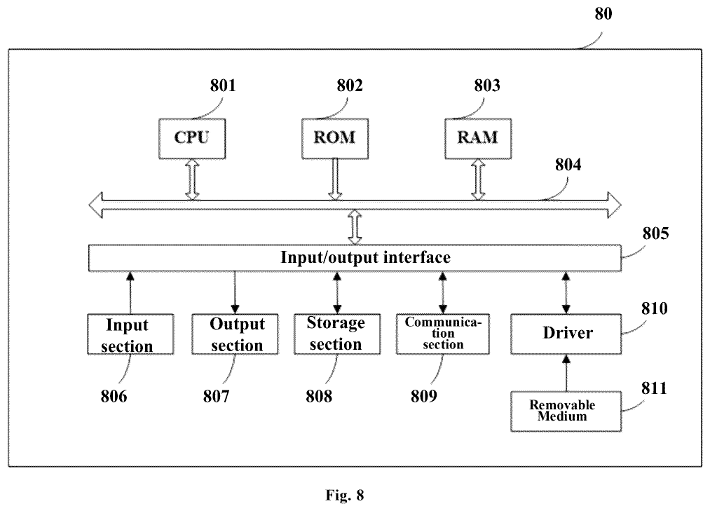

In addition, according to some embodiments of the present disclosure, when the various operations/processes according to the present disclosure are implemented by using software and/or firmware, a program constituting the software may be installed from a storage medium or a network to a computer system with a dedicated hardware structure, for example, the computer system 80 shown in FIG. 8. When the computer system is installed with various programs, the computer system can perform various functions, including functions such as those described above. FIG. 8 is a block diagram showing an example structure of a computer system that can be used in the embodiments of the present disclosure.

In FIG. 8, a central processing unit (CPU) 801 performs various processes in accordance with a program stored in a read-only memory (ROM) 802 or a program loaded from a storage section 808 into a random access memory (RAM) 803. The RAM 803 also stores, as required, data required when the CPU 801 performs the various processes and the like. The central processing unit is merely an example, and may be another type of processor, such as various processors described above. The ROM 802, the RAM 803, and the storage section 808 may be various forms of computer-readable storage media, as described below. It should be noted that although the ROM 802, the RAM 803, and the storage section 808 are shown separately in FIG. 8, one or more of them may be combined or located in the same or different memories or storage modules.

The CPU 801, the ROM 802, and the RAM 803 are connected to each other via a bus 804. An input/output (I/O) interface 805 is also connected to the bus 804.

The following components are connected to the I/O interface 805: an input section 806 including a touchscreen, a touchpad, a keyboard, a mouse, an image sensor, a microphone, an accelerometer, a gyroscope, and the like; an output section 807 including a display such as a cathode ray tube (CRT) and a liquid crystal display (LCD), a speaker, a vibrator, and the like; the storage section 808 including a hard disk, a tape, and the like; and a communication section 809 including a network interface card such as a LAN card and a modem. The communication section 809 allows a communication process to be performed via a network such as the Internet. It is easy to understand that although the devices or modules in the computer system 80 are shown in FIG. 8 to communicate with each other via the bus 804, they may also communicate via a network or other means, where the network may include a wireless network, a wired network, and/or any combination of a wireless network and a wired network.

A drive 810 is also connected to the I/O interface 805 as required. A removable medium 811 such as a magnetic disk, an optical disk, a magneto-optical disk, a semiconductor memory, and the like is installed on the drive 810 as required, so that a computer program read therefrom is installed into the storage section 808 as required.

When the above series of processes are implemented by software, a program constituting the software may be installed from a network such as the Internet or a storage medium such as the removable medium 811.

According to the embodiments of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network via the communication unit 809, or installed from the storage unit 808, or installed from the ROM 802. When the computer program is executed by the CPU 801, the above-mentioned functions defined in the method of this embodiment of the present disclosure are performed.

It should be noted that in the context of the present disclosure, the computer-readable medium may be a tangible medium that may contain or store a program used by or in combination with an instruction execution system, apparatus, or device. The computer-readable medium may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, and the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. Program code contained in the computer-readable medium may be transmitted by any suitable medium, including but not limited to: electric wires, optical cables, radio frequency (RF), etc., or any suitable combination thereof.

The foregoing computer-readable medium may be contained in the foregoing electronic device. Alternatively, the computer-readable medium may exist independently, without being assembled into the electronic device.

In some embodiments, a computer program is further provided. The computer program includes instructions that, when executed by a processor, cause the processor to perform the method according to any one of the foregoing embodiments. For example, the instructions may be embodied as computer program code.

In the embodiments of the present disclosure, the computer program code for performing the operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any type of network (including a local area network (LAN) or a wide area network (WAN)), or may be connected to an external computer (for example, connected through the Internet using an Internet service provider).

The flowcharts and block diagrams in the accompanying drawings illustrate a possible system architecture, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules, components, or units described in the embodiments of the present disclosure may be implemented by using software, or may be implemented by using hardware. The name of a module, a component, or a unit does not impose a limitation on the module, the component, or the unit in some cases.

The functions described herein may be performed at least partially by one or more hardware logic components. For example, without limitation, exemplary hardware logic components that may be used include: a field programmable gate array (FPGA), an application-specific integrated circuit (ASIC), an application-specific standard product (ASSP), a system on chip (SOC), a complex programmable logic device (CPLD), and the like.

The foregoing descriptions are merely some embodiments of the present disclosure and explanations of the applied technical principles. A person skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features with similar functions disclosed in the present disclosure (but not limited to) is also covered in the scope of the present disclosure.

In the descriptions provided herein, numerous specific details are set forth. However, it is understood that embodiments of the present invention may be implemented without these specific details. In other instances, well-known methods, structures, and technologies are not shown in detail to avoid obscuring an understanding of this description.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although some specific embodiments of the present disclosure are described in detail by using examples, persons skilled in the art should understand that the above examples are merely for illustration, rather than limiting the scope of the present disclosure. Persons skilled in the art should understand that the above embodiments may be modified without departing from the scope and spirit of the present disclosure. The scope of the present disclosure is defined by the appended claims.

What is claimed is:

1. An information generation method, comprising:
determining, based on intention information of a topic, whether the topic reflects key information of one or more topic posts of the topic;
determining, in response to the topic not reflecting the key information of the topic posts, supplementary information of the topic based on the topic posts; and
displaying the topic and the supplementary information.

2. The information generation method according to claim 1, further comprising:
classifying intention words of the one or more topic posts; and
determining the key information based on intention word(s) in a category associated with a largest quantity of topic posts.

3. The information generation method according to claim 2, wherein the classifying intention words in the one or more topic posts comprises:
clustering the intention words of the one or more topic posts; or
determining dimension(s) to which the intention words of the one or more topic posts belong, and classifying the intention words of the one or more topic posts based on the dimension(s).

4. The information generation method according to claim 1, wherein the determining, based on the intention information of the topic, whether the topic reflects key information of the one or more topic posts of the topic comprises:
in response to the intention information of the topic indicating that the topic has no intention, determining that the topic does not reflect the key information of the topic posts.

5. The information generation method according to claim 1, wherein the determining, based on the intention information of the topic, whether the topic reflects the key information of the one or more topic posts of the topic comprises:
determining the key information of the topic posts based on intention words of the one or more topic posts;
in response to the intention words of the topic matching the key information of the one or more topic posts, determining that the topic reflects the key information of the topic posts of the topic; and
in response to the intention words of the topic not matching the key information of the one or more topic posts, determining that the topic does not reflect the key information of the topic posts of the topic.

6. The information generation method according to claim 1, wherein determining the supplementary information of the topic based on the topic posts comprises:
determining the supplementary information of the topic based on the topic posts related to the key information.

7. The information generation method according to claim 6, wherein the determining the supplementary information of the topic based on the topic posts comprises:
using text, or a recommended book, or a recommended author of at least one of the topic posts related to the key information as the supplementary information; or
processing, by using a machine learning model, the at least one of the topic posts related to the key information, to obtain the supplementary information output by the machine learning model.

8. The information generation method according to claim 7, wherein the at least one of the topic posts related to the key information is a topic post with a highest amount of information, and the amount of information in the topic post is determined based on at least one of text of the topic post, publisher information of the topic post, information about a recommended book of the topic post, intention information of the topic post, or a correlation with the topic of the topic post.

9. The information generation method according to claim 3, wherein the dimension comprises at least one of an author, a plot, a subject, an evaluation, or a book status.

10. The information generation method according to claim 1, further comprising:
in response to a triggering operation on the topic, displaying a presentation page for presenting the one or more topic posts.

11. The information generation method according to claim 1, further comprising:
processing, by using an intention analysis model, a title and description information of the topic to obtain the intention information of the topic; or
processing, by using the intention analysis model, the topic posts to obtain the intention information of the topic posts.

12. An information generation apparatus, comprising:
a memory; and
a processor coupled to the memory and configured to, based on instructions stored in the memory, perform an information generation method comprising:
determining, based on intention information of a topic, whether the topic reflects key information of one or more topic posts of the topic;
determining, in response to the topic not reflecting the key information of the topic posts, supplementary information of the topic based on the topic posts; and
displaying the topic and the supplementary information.

13. The information generation apparatus according to claim 12, wherein the processor is further configured to:
classify intention words of the one or more topic posts; and
determine the key information based on intention word(s) in a category associated with a largest quantity of topic posts.

14. The information generation apparatus according to claim 13, wherein the classifying intention words in the one or more topic posts comprises:
clustering the intention words of the one or more topic posts; or
determining dimension(s) to which the intention words of the one or more topic posts belong, and classifying the intention words of the one or more topic posts based on the dimension(s).

15. The information generation apparatus according to claim 12, wherein the determining, based on the intention information of the topic, whether the topic reflects key information of the one or more topic posts of the topic comprises:
in response to the intention information of the topic indicating that the topic has no intention, determining that the topic does not reflect the key information of the topic posts.

16. The information generation apparatus according to claim 12, wherein the determining, based on the intention information of the topic, whether the topic reflects the key information of the one or more topic posts of the topic comprises:
determining the key information of the topic posts based on intention words of the one or more topic posts;
in response to the intention words of the topic matching the key information of the one or more topic posts, determining that the topic reflects the key information of the topic posts of the topic; and
in response to the intention words of the topic not matching the key information of the one or more topic posts, determining that the topic does not reflect the key information of the topic posts of the topic.

17. The information generation apparatus according to claim 12, wherein determining the supplementary information of the topic based on the topic posts comprises:
determining the supplementary information of the topic based on the topic posts related to the key information.

18. The information generation apparatus according to claim 17, wherein the determining the supplementary information of the topic based on the topic posts comprises:
using text, or a recommended book, or a recommended author of at least one of the topic posts related to the key information as the supplementary information; or
processing, by using a machine learning model, the at least one of the topic posts related to the key information, to obtain the supplementary information output by the machine learning model.

19. The information generation apparatus according to claim 18, wherein the at least one of the topic posts related to the key information is a topic post with a highest amount of information, and the amount of information in the topic post is determined based on at least one of text of the topic post, publisher information of the topic post, information about a recommended book of the topic post, intention information of the topic post, or a correlation with the topic of the topic post.

20. A non-transitory computer-readable storage medium having stored thereon a computer program that, when executed by a processor, causes processor to perform an information generation method comprising:
determining, based on intention information of a topic, whether the topic reflects key information of one or more topic posts of the topic;
determining, in response to the topic not reflecting the key information of the topic posts, supplementary information of the topic based on the topic posts; and
displaying the topic and the supplementary information.
